(19) United States
(12) Patent Application Publication
(10) Pub. No.: US 2008/0065742 A1
(43) Pub. Date: Mar. 13, 2008

(54) CONTEXTUALLY CATEGORIZATION OF COMPLEX DATA REPOSITORIES IN AN INFORMATION ARCHITECTURE ANALYSIS

(75) Inventors: Kei-Leung Albert Lun, Rochester, MN (US); Tinny Mei Chi Ng, Toronto (CA); Linh Dinh Nguyen, Cary, NC (US); Christopher Paul Parsons, Southampton (GB)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/530,250

(22) Filed: Sep. 8, 2006

(51) Int. Cl. G06F 15/16; G06F 15/173

(52) U.S. Cl. 709/217; 709/223; 709/203

(57) ABSTRACT

Embodiments of the present invention address deficiencies of the art in respect to the analysis of an information architecture, and provide a method, system and computer program product for contextually categorizing complex data repositories in an information architecture analysis. In an embodiment of the invention, a contextual analysis method for an information architecture can be provided. The method can include identifying a set of roles accessing information within the information architecture, and locating artifacts within the information architecture and determining information systems providing access to the located artifacts. The method further can include linking the roles in the set with the determined information systems, and producing a top-down, multi-faceted contextual view of the information architecture with the roles, artifacts and information systems.

### BACKGROUND OF THE INVENTION

1. Field of the Invention

The present invention relates to the field of enterprise computing and network administration, and more particularly to the analysis of an information architecture of multiple data repositories.

2. Description of the Related Art

The task of modern network administration differs significantly from that of days gone by. Not just a decade ago, network administration primarily entailed the addition and deletion of network users, the management of print queues, and the supervision and operation of daily backup procedures. Most if not all resources required by network applications remained present in the network itself, and few if any network applications depended upon the operation of other, co-executing applications. In fact, the notion of an enterprise application, as compared to a mere network application remained largely within the realm of academia as a decade ago, the enabling technologies had not advanced enough in terms of speed and reliability to facilitate true enterprise computing.

Much has changed since the early days of network computing. Today, enterprise computing permeates the electronic landscape. While some enterprise applications remain largely stand-alone, most rely in some respect on a co-existing enterprise application or a soft enterprise resource, such as a database application, Web application server, or other cooperating component. Thus, the administration of the network has advanced far beyond user and print queue administration and daily backup routines. Today, the inter-dependencies among network components present a significant challenge to the network administrator. In this regard, the management of a single network component can depend upon the state of a multiplicity of other network components.

The modern enterprise application depends upon an information architecture bursting with data. Vast amounts of information for the information architecture often are disposed within a multiplicity of dispersed data repositories. Yet, access to the information within each repository can be governed according to the logic of many different applications. As in the case of the data repositories, the different applications can operate within correspondingly different systems. Thus, the information infrastructure often can become so complicated that the performance experienced within the enterprise application can become degraded.

To improve performance and provide a rapid return on investment of an enterprise system, consolidation can be of paramount importance. Notwithstanding, before consolidation, the network administrator first must have an overall picture of the information architecture. To that end, the network administrator must identify each information system and fully understand its usage. Academically, to achieve the identification and understanding of an information architecture, network administrators answer the “five Ws” of information access. The five Ws include “Who needs to access the information?”, “Why must the user access the information?”, “When must the user access the information?”, “Where is the information?”, and “What application is required to access the information?”.

At present, there is lack of a well-defined methodology that can facilitate the categorization of an existing, information architecture. In fact, the chain of analysis from process, to use-case, to artifact to information system cannot be viewed in a coherent manner without undertaking an exhaustive, granular bottom up view of the information architecture. Nevertheless, conventional techniques for analyzing an information architecture depend largely upon a structural decomposition of the information architecture without accounting for the context for the information within the information architecture.

### BRIEF SUMMARY OF THE INVENTION

Embodiments of the present invention address deficiencies of the art in respect to the analysis of an information architecture, and provide a novel and non-obvious method, system and computer program product for contextually categorizing complex data repositories in an information architecture analysis. In an embodiment of the invention, a contextual analysis method for an information architecture can be provided. The method can include identifying a set of roles accessing information within the information architecture, and locating artifacts within the information architecture and determining information systems providing access to the located artifacts. The method further can include linking the roles in the set with the determined information systems, and producing a top-down, multi-faceted contextual view of the information architecture with the roles, artifacts and information systems.

In another embodiment of the invention, an information architecture contextual analysis data processing system can be provided. The system can include a multiplicity of nodes, each node including at least one of a repository, an information system, and an artifact disposed in the repository. The system also can include a host computing platform coupled to the nodes over a computer communications network. Finally, the system can include contextual analysis logic. The logic can include program code enabled to identify a set of roles accessing information within the information architecture, to locate artifacts within the information architecture and to determine information systems providing access to the located artifacts, to link the roles in the set with the determined information systems and to produce a top-down, multi-faceted contextual view of the information architecture with the roles, artifacts and information systems.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a system, method and computer program product for contextually categorizing complex data repositories in an information architecture analysis;

FIG. 2 is a schematic illustration of a data processing system configured for contextually categorizing complex data repositories in an information architecture analysis;

FIG. 3 is a flow chart illustrating a process for contextually categorizing complex data repositories in an information architecture analysis; and,

FIG. 4 is a screen shot series of a navigator user interface configured for contextually categorizing complex data repositories in an information architecture analysis.

### DETAILED DESCRIPTION OF THE INVENTION

Embodiments of the present invention provide a method, system and computer program product for contextually categorizing complex data repositories in an information architecture analysis. In accordance with an embodiment of the present invention, an information architecture for an enterprise system can be analyzed in a contextual top-down approach to generate a multi-faceted view of the granular elements of the information architecture. The contextual top-down approach can include identifying the different processes configured for operation in the enterprise system and the various use-cases for each of the processes. The roles accessing the different use cases can be determined as can the artifacts required to complete the different use cases.

In particular, the location of the artifacts within the information architecture and the information systems required to access the artifacts can be identified. Finally, the roles can be resolved to corresponding artifacts and applications through a linking process. A resulting report can be generated correlating the different processes, use-cases, roles, artifacts, and information systems. The different relationships recognizable within the report can be rendered visually in a navigator user information. In this way, an administrator can analyze relationship between the different processes, use-cases, roles, artifacts, and information systems for the information architecture. Furthermore, one or more rules can be applied to the report to automatically flag observations for the information architecture including redundancies in the location of the artifacts and duplicate instances of information systems.

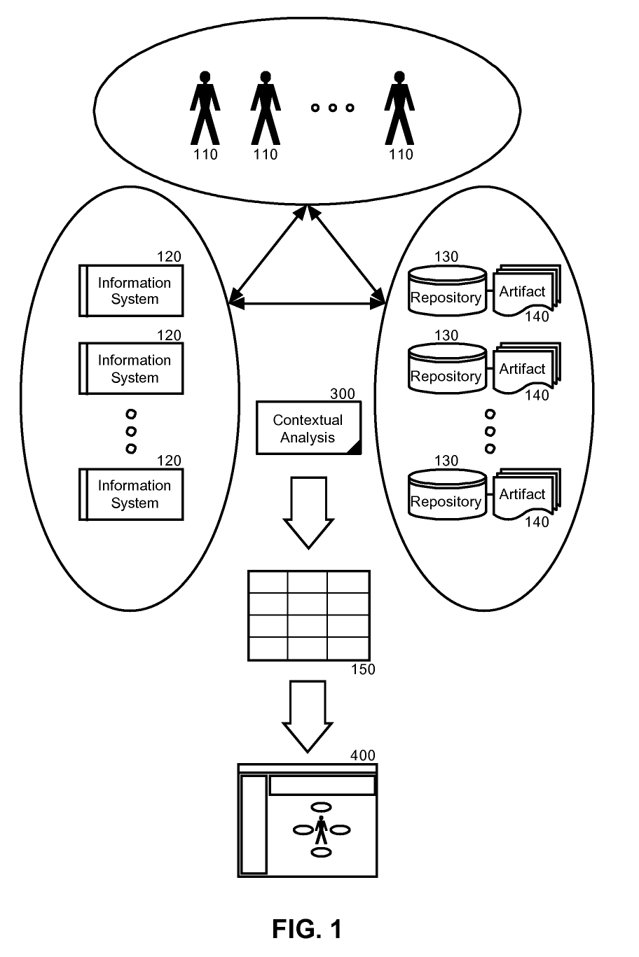

In illustration, FIG. 1 is a pictorial illustration of a system, method and computer program product for contextually categorizing complex data repositories in an information architecture analysis. As shown in FIG. 1, one or more roles 110 can utilize one or more information systems 120 to access one or more artifacts 140 disposed in one or more repositories 130 in an information architecture. Generally, the artifacts 140 can include data objects whose access can be moderated and facilitated through the use of corresponding information systems 120. Notably, in the information architecture, multiple information systems 120 can be used to access a single one of the artifacts 140 and any individual one of the artifacts 140 can be disposed in multiple, different ones of the repositories 140.

A contextual analysis 300 can be performed upon the information architecture in order to produce a report 150. The contextual analysis 300 can include a contextual, top-down approach to answering the 5 W's of what, when, why, where and who by reference to the actual usage of artifacts in the information architecture. To that end, the contextual analysis 300 can begin by identifying the processes performed utilizing the information architecture and the use cases for each of the processes. The roles associated with each of the use cases also can be identified as can the artifacts utilized as both input and output to the use cases. Finally, the roles for the use cases can be linked to the artifacts in the report 150.

Utilizing the report 150, a multi-faceted, contextual view of the information architecture can be produced. The multi-faceted, contextual view can show from any of the actor, use case, artifact or information system view the relationship between the different aspects of usage of artifacts in the information architecture. For instance, a view can be produced showing all roles associated with an artifact, or all artifacts associated with a role. A view further can be produced to show all information systems accessed by a role, or all information systems providing or managing access to an artifact. A view yet further can be produced to show all artifacts created by or consumed by a selected use case. In any event, a navigator user interface 400 can be provided to facilitate the visual presentation and navigation of the various views.

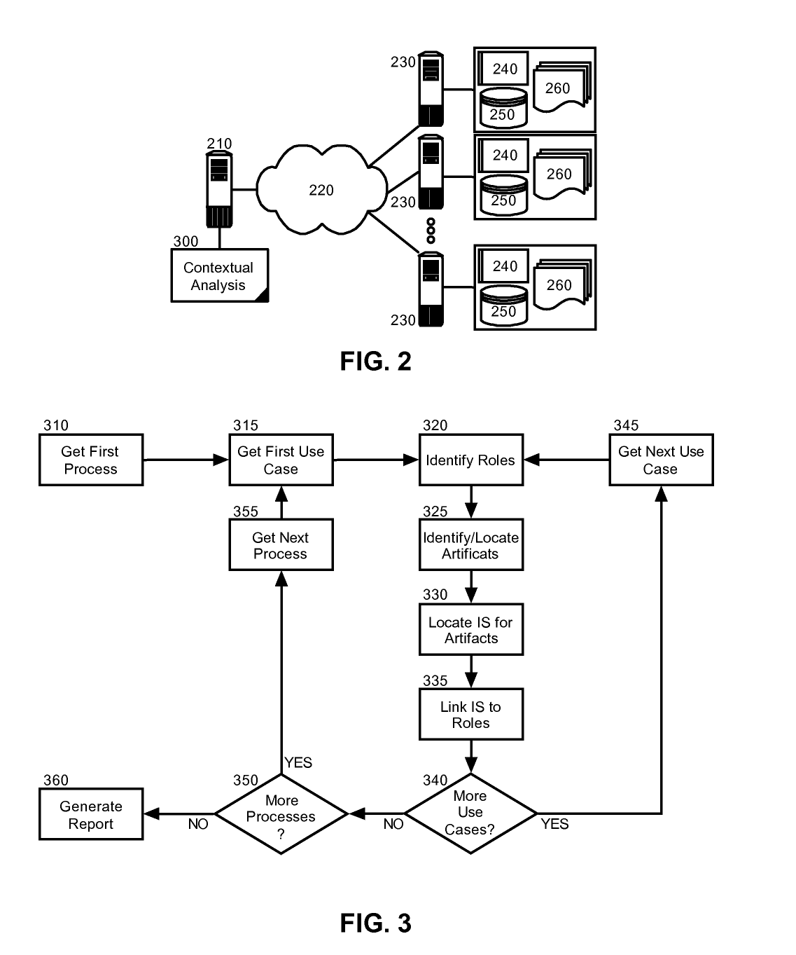

In more particular illustration, FIG. 2 is a schematic illustration of a data processing system configured for contextually categorizing complex data repositories in an information architecture analysis. The system can include a host computing platform 210 configured for communicative coupling to one or more computing nodes 230 over a computer communications network 220. The computing nodes can include one or more of an information system 240 programmed to provide access to or manage artifacts 260 disposed in a repository 250. The artifacts 260 can include, by way of example, data objects in a table, or files in a file system.

The host computing platform 210 can include contextual analysis logic 300. The contextual analysis logic 300 can include program code enabled to perform a top-down, contextual analysis of an information architecture incorporating the nodes 230 and the respective information systems 240, artifacts 260 and repositories 250. The top-down, contextual analysis of the contextual analysis logic 300 can include the identification of the processes executing in the nodes 230, the use cases for each of the processes and the roles associated with each of the use cases. The top-down, contextual analysis of the contextual analysis logic 300 further can include the identification and location of artifacts used in each of the use cases, whether input or output, and the information systems used to access the artifacts. Finally, top-down, contextual analysis of the contextual analysis logic 300 can be enabled to link the roles to the artifacts in a resulting report.

In yet further illustration, FIG. 3 is a flow chart illustrating a process for contextually categorizing complex data repositories in an information architecture analysis. The process can begin in block 310 with the retrieval of a first process in the enterprise system utilizing the information architecture. In block 315, a first use case for the process can be selected and in block 320, the roles associated with the use case can be determined. In block 325, the artifacts for the use case can be identified and located, including those artifacts consumed by the use case as input and those produced by the use case as output. Additionally, in block 330, the location of the identified artifacts can be determined. Finally, the information systems manage access to or utilizing the artifacts can be determined.

Importantly, in block 335 a linkage or association can be established between the information systems managing access to or utilizing the determined artifacts and the roles associated with the use cases for the identified artifacts. Thereafter, in decision block 340, if additional use cases remain for the process, in block 345 the next use case can be selected for processing and the process can repeat through block 320. When no further used cases remain in the process, in decision block 350 it can be determined if there are additional processes utilizing the information architecture. If so, the next process utilizing the information architecture can be selected for processing and the process can continue through block 315. When no further processes remain to selected, the process can end in block 360.

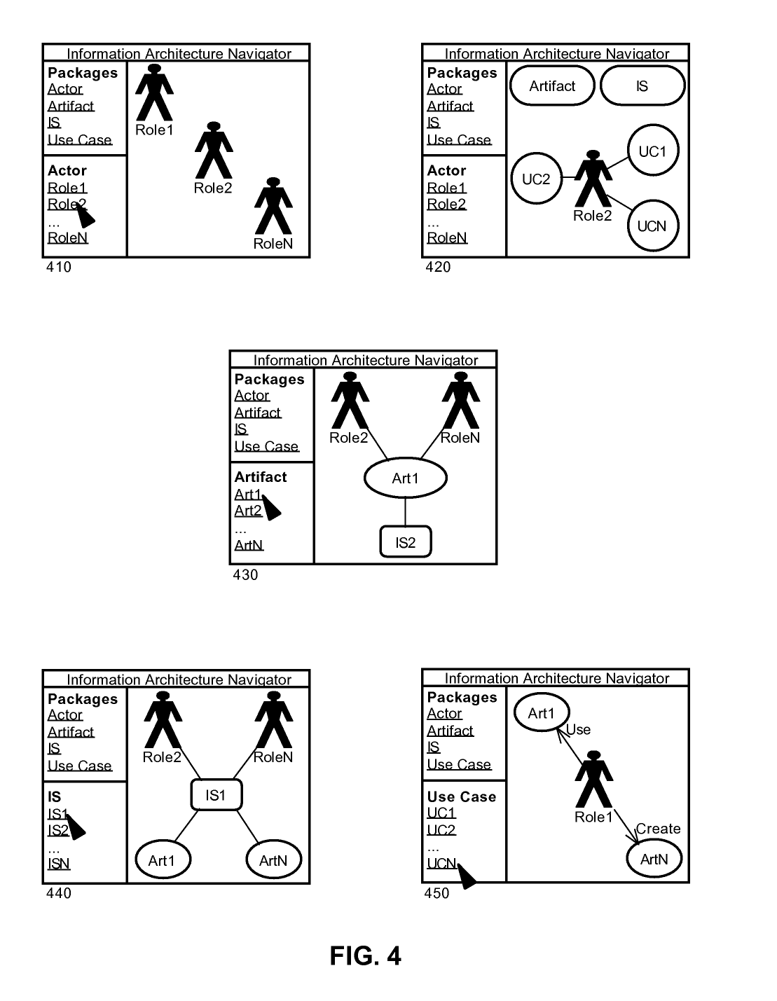

Notably, the foregoing process can act to produce a report of process, use cases, roles, artifacts and information systems and their respective interrelationships. Thereafter, a navigator user interface can be provided to analyze the data in the report. Additionally, observations can be developed from a review of the report, such as the case where artifacts can be located in multiple, different repositories unnecessarily, or where multiple different information systems access the same artifact unnecessarily. In more particular illustration, FIG. 4 is a screen shot series of a navigator user interface configured for contextually categorizing complex data repositories in an information architecture analysis.

As shown in FIG. 4, an information architecture navigator can produce a number of user selectable views 410, 420, 430, 440, 450. Those views can include a role-centric view 410 of all roles provided for by the information architecture. A selection of any one of the roles in the role-centric view 410 can produce a different, individual role view 420. The individual role view 420 can show all use cases associated with a selected role. The individual role view 420 also can provide for selection for rendering a role-centric view (not shown) showing all artifacts associated with a selected role, and a selection for rendering a role-centric view (not shown) showing all information systems associated with a selected role.

The views further can include an artifact-centric view 430. The artifact-centric view 430 can show all roles associated with a selected artifact, as well as all information systems managing access to or utilizing the selected artifact. Similarly, the views can include an information system-centric view 440. The information system-centric view 440 can show all roles associated with a selected information system, as well as all artifacts having access managed by or being utilized by the selected information system. Finally, the views can include a use-case centric view 450. The use-case centric view 450 can provide a view of a selected use case including associated roles, and the artifacts consumed by and created by a selected use case.

Utilizing the navigation user interface of FIG. 1 and the specific views of FIG. 4, the following observations can be gained. First, the views can provide the frequent requirement of driving convergence by highlighting disparate information systems and artifacts used for similar purposes. Second, the views can illustrate where information systems are already well established and should be used as a best practice. Third, the views can show where information is duplicated within the information architecture, and further where information systems are duplicated or where multiple instances exist.

The views further can facilitate an understanding of the complexity of how information is used and the views can facilitate an illustration of the cost of managing information. The views also can facilitate an understanding of any lack of consistency and associated costs when using multiple information systems and artifacts. The views yet further can facilitate a gap analysis of what information is missing and where bottlenecks exist. Finally, the views can support the general requirement to eliminate unstructured and inconsistent information.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A contextual analysis method for an information architecture comprising:
identifying a set of roles accessing information within the information architecture;
locating artifacts within the information architecture and determining information systems providing access to the located artifacts;
linking the roles in the set with the determined information systems; and,
producing a top-down, multi-faceted contextual view of the information architecture with the roles, artifacts and information systems.

2. The method of claim 1, wherein identifying a set of roles accessing information within the information architecture, comprises:
identifying all processes utilizing the information architecture;
further identifying all use cases for each of the processes; and,
yet further identifying all associated roles for each of the use cases.

3. The method of claim 2, wherein locating artifacts within the information architecture and determining information systems providing access to the located artifacts, comprises even yet further identifying and locating all artifacts either consumed by or created by each of the use cases.

4. The method of claim 3, wherein linking the roles in the set with the determined information systems, comprises:
for each role among the set of roles, associating the role with information systems determined to provide access to artifacts utilized in use cases associated with the role; and,
writing each association in a report.

5. The method of claim 4, further comprising rendering a navigation user interface from the report.

6. The method of claim 4, further comprising developing observations from the report.

7. An information architecture contextual analysis data processing system comprising:
a plurality of nodes, each node comprising at least one of a repository, an information system, and an artifact disposed in the repository;
a host computing platform coupled to the nodes over a computer communications network; and,
contextual analysis logic comprising program code enabled to identify a set of roles accessing information within the information architecture, to locate artifacts within the information architecture and to determine information systems providing access to the located artifacts, to link the roles in the set with the determined information systems and to produce a top-down, multi-faceted contextual view of the information architecture with the roles, artifacts and information systems.

8. The system of claim 7, further comprising additional program code of the contextual analysis logic to render a navigation user interface from the top-down, multi-faceted contextual view of the information architecture.

9. A computer program product comprising a computer usable medium having computer usable program code for contextually analyzing an information architecture, said computer program product including:
computer usable program code for identifying a set of roles accessing information within the information architecture;
computer usable program code for locating artifacts within the information architecture and determining information systems providing access to the located artifacts;
computer usable program code for linking the roles in the set with the determined information systems; and,
computer usable program code for producing a top-down, multi-faceted contextual view of the information architecture with the roles, artifacts and information systems.

10. The computer program product of claim 9, wherein the computer usable program code for identifying a set of roles accessing information within the information architecture, comprises:
computer usable program code for identifying all processes utilizing the information architecture;
computer usable program code for further identifying all use cases for each of the processes; and,
computer usable program code for yet further identifying all associated roles for each of the use cases.

11. The computer program product of claim 10, wherein the computer usable program code for locating artifacts within the information architecture and determining information systems providing access to the located artifacts, comprises computer usable program code for even yet further identifying and locating all artifacts either consumed by or created by each of the use cases.

12. The computer program product of claim 11, wherein the computer usable program code for linking the roles in the set with the determined information systems, comprises:
computer usable program code for associating, for each role among the set of roles, the role with information systems determined to provide access to artifacts utilized in use cases associated with the role; and,
computer usable program code for writing each association in a report.

13. The computer program product of claim 12, further comprising computer usable program code for rendering a navigation user interface from the report.

14. The computer program product of claim 12, further comprising computer usable program code for developing observations from the report.
